(19) United States
(12) Patent Application Publication
(10) Pub. No.: US 2004/0232106 A1
(43) Pub. Date: Nov. 25, 2004

(54) Method of manufacturing a mirror and a mirror device

(76) Inventors: Kazunari Oka, Chiba-shi (JP); Minoru Sudo, Chiba-shi (JP); Takashi Niwa, Chiba-shi (JP); Norio Chiba, Chiba-shi (JP); Susumu Ichihara, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/820,312

(22) Filed: Apr. 8, 2004

(30) Foreign Application Priority Data
Apr. 9, 2003 (JP) 2003-105129
Mar. 5, 2004 (JP) 2004-062184

(51) Int. Cl. B29D 11/00

(52) U.S. Cl. 216/26

(57) ABSTRACT

A method of manufacturing a mirror having high verticality and less surface roughness, comprising forming a mask material to the surface of a silicon substrate, applying anisotropic dry etching and anisotropic wet etching, thereby anisotropically dry etching the surface substantially parallel with the crystal face in perpendicular to the surface of the substrate and then forming a reflection surface by the anisotropic wet etching step.

### BACKGROUND OF THE INVENTION

1. Field of the Invention

The present invention concerns a method of manufacturing a mirror by fabricating a silicon substrate and a mirror device manufactured by using the manufacturing method.

2. Description of the Related Art

MEMS (Micro Electro Mechanical System) technique have been developed remarkably in recent years by the application of the semiconductor micro-fabrication. Particularly, application of the MEMS technology to the optical technology has been developed remarkably in recent years. The technique described above has been utilized in image processing apparatus such as scanners and micro mirror array displays, and in the field of information communication such as read/write devices for use in micro miniature high density optical memories. One of the devices described above has a micro-mirror for scanning of light and switching of optical channels by driving the micro-mirror. Accordingly, the micro-mirror is a key part determining the characteristics of the device. In order to transmit light at high efficiently, a high reflectivity is required for the micro-mirror. Further, in a case of manufacturing a device having plural micro-mirrors on one identical plane or in a case of conducting passive alignment between a micro-mirror and an optical fiber by using an optical bench, since it is necessary that the incident light is reflected to a desired portion, the verticality of the micro-mirror relating to the surface of a substrate in which the micro-mirror is formed is improved. As described above, it can be said that a high reflectivity and a verticality to the surface of the substrate are important factors for the micro-mirror.

In a case of manufacturing a micro-mirror to a silicon substrate, a method of forming a mask using a material such as silicon dioxide or silicon nitride on a silicon substrate and applying anisotropic wet etching or anisotropic dry etching is adopted. In the anisotropic wet etching, a specified crystal face is exposed by utilizing the difference of the etching rate depending on the crystal face of the silicon substrate to prepare a reflection surface. In the anisotropic wet etching, since the reflection surface is prepared by exposing the crystal face, a high alignment accuracy is necessary for the positional alignment between the mask shape and the crystallographic direction of the silicon substrate.

Means for improving the alignment accuracy can include the following steps (for example, refer to G. Ensell; Alignment of mask patterns to crystal orientation, Sensors and Actuators A 53, (1996) 345-348)):

(Step 1) After depositing a mask material comprising silicon dioxide or silicon nitride on a silicon substrate, a circular or square mask material pattern is formed by photolithography.

(Step 2) An alignment pattern constituted with a crystal face is formed on the silicon substrate by anisotropic wet etching using an alkali solution such as an aqueous solution of potassium hydroxide (KOH) or an aqueous solution of tetramethyl ammonium hydroxide (TMAH).

(Step 3) The alignment pattern constituted with the crystal face and the direction of the mask forming the micro-mirror are aligned to conduct alignment.

Since the reflection surface of the micro-mirror prepared by anisotropic wet etching is constituted with the crystal face, the surface roughness is small, high reflectivity can be obtained and the verticality is high.

A manufacturing method by using the anisotropic dry etching has a merit, compared with the case of the anisotropic wet etching, in that the micro-mirror can be formed easily conforming the mask pattern, the degree of freedom of the pattern is high and the etching time can be shortened. Recently, anisotropic dry etching using DRIE (Deep Reactive Ion Etching) is predominant as a method of manufacturing a micro-mirror vertical to the substrate. A mirror precursor is prepared by using the anisotropic dry etching and the etched portion is thermally oxidized. The fabrication side wall is protected by thermal oxidation and a micro-mirror is formed by anisotropic wet etching. The thickness of the micro-mirror can be controlled depending on the time for anisotropic wet etching (for example, refer to JP-A No. 2001-56440 (claims 1 to 6, FIG. 5).

Further, a method of combining the anisotropic dry etching and the anisotropic wet etching is also used (for example, refer to M. Sasaki: Anisotropic Si Etching Technique for Optically Smooth Surface, TRANSDUCERS' 01 2B3.03). The mirror outer profile was formed by the anisotropic dry etching and a specified crystal face is exposed by etching using an alkali solution. By the method, the fabrication surface has a high verticality and the surface roughness is decreased. A completed structure is utilized for a mold.

In case a of manufacturing a micro-mirror by the anisotropic wet etching, it results in problems such as etching time is long and a mask pattern is complicated for obtaining a desired mirror shape.

Further, in a case of manufacturing a micro-mirror by the method as described in JP-A No. 2001-56440, a mirror precursor is formed by the anisotropic dry etching. However, since a (100) substrate is used, the (100) face is formed as a mirror and anisotropic wet etching is used for manufacturing a micro-mirror, a mirror precursor of a width equal with or larger than the height of the micro-mirror is necessary, which results in a significant problem of not capable of coping with increase in integration degree.

Further, in a case of manufacturing a micro-mirror using the {110} face as a reflection surface by the combination of the anisotropic dry etching and the anisotropic wet etching, it maybe considered to use ethylene diamine pyrocatechol (EPW) as described by M. Sasaki in the literature described above. However, restriction of the reflection surface of the micro-mirror to a specified crystal face lowers the degree of freedom in the design of the device. Further, when EPW undergoes long time anisotropic etching relative to the silicon substrate, precipitates are formed in an etchant and the precipitates are accumulated to the etched portion. In a case where the precipitates are deposited to the reflection surface of the micro-mirror, they constitute micromasks to increase the surface roughness. Furthermore, since EPW is carcinogenic, it is deleterious to human bodies.

In view of the above, the present invention has been accomplished in order to solve the foregoing problems and manufacture a micro-mirror having a verticality and small surface roughness, and the invention intends to provide a method of manufacturing a micro-mirror by using anisotropic dry etching technique and anisotropic wet etching technology, and utilizing the crystal face of silicon, and combining them.

### SUMMARY OF THE INVENTION

The present invention provides a method of manufacturing a mirror having a reflection surface vertical to the surface of a silicon substrate comprising;

a step of forming a mask for forming a mask material to the surface of the substrate, an anisotropic dry etching step of anisotropically dry etching the substrate, and an anisotropic wet etching step of anisotropically wet etching the substrate, and forming a surface substantially parallel with a crystal face in perpendicular to the surface of the substrate by the anisotropic dry etching step and then forming the reflection surface by the anisotropic wet etching step.

In a preferred embodiment, an angle formed between a portion of a fabricated side wall formed to the substrate at least corresponding to the reflection surface and the surface of the substrate is 90°±3° in the anisotropic dry etching step.

In a further preferred embodiment, the surface roughness for the portion of the fabricated side wall formed to the substrate at least corresponding to the reflection surface is 300 nm or less in the anisotropic dry etching step.

In a further preferred embodiment, a silicon exposed portion is provided to the outer periphery of the substrate in the anisotropic dry etching step.

In a further preferred embodiment, a cleaning step is included between the anisotropic dry etching step and the anisotropic wet etching step.

In a further preferred embodiment, oxygen plasma is irradiated to the substrate in the cleaning step.

In a further preferred embodiment, argon plasma is irradiated to the substrate in the cleaning step.

In a further preferred embodiment, the substrate is immersed in a liquid mixture of sulfuric acid and an aqueous hydrogen peroxide in the cleaning step.

In a further preferred embodiment, the substrate is immersed in a heated sulfuric acid in the cleaning step.

In a further preferred embodiment, the etchant is an aqueous solution of potassium hydroxide in the anisotropic wet etching step.

In a further preferred embodiment, the etchant is potassium hydroxide with addition of isopropyl alcohol in the anisotropic wet etching step.

In a further preferred embodiment, the etchant is tetramethyl ammonium hydroxide in the anisotropic wet etching step.

In a further preferred embodiment, the etchant is tetramethyl ammonium hydroxide in the anisotropic wet etching step, and the liquid temperature is 60° C. or higher and the 70° C. or lower.

In a further preferred embodiment, the etchant is an aqueous solution of tetramethyl ammonium hydroxide in the anisotropic wet etching step, and the etching amount is 0.5 μm or more and 3 μm or less.

In a further preferred embodiment, the etchant is tetramethyl ammonium hydroxide with addition of silicon in the anisotropic wet etching step.

In a further preferred embodiment, the etchant is tetramethyl ammonium hydroxide with addition of silicon and ammonium persulfate in the anisotropic wet etching step.

In a further preferred embodiment, the etchant is ammonia with addition of arsenic oxide in the anisotropic wet etching step.

In a further preferred embodiment, the crystal face on the surface of the substrate is {100} face, and the crystal face as the reflection surface is {100} face or {110} face.

In a further preferred embodiment, the crystal face in the surface of the substrate is {110} face, and the crystal face as the reflection surface is {100} face, {110} face, or {111} face.

In a further preferred embodiment, the crystal face on the surface of the substrate is {111} face, and the crystal face as the reflection surface is {110} face.

In a further preferred embodiment, including a step of coating a thin film on the reflection surface.

In a further preferred embodiment, the thin film is formed of at least one layer of a metal film in the step of coating the thin film on the reflection surface.

In a further preferred embodiment, the thin film is formed of at least one layer of a dielectric material in the step of coating the thin film on the reflection surface.

In a further preferred embodiment, the film deposition method for the thin film is an oblique vapor deposition method using a vacuum vapor deposition method in the step of coating the thin film on the reflection surface.

In a further preferred embodiment, the film deposition method for the thin film is a sputtering method in the step of coating the thin film on the reflection surface.

In a further preferred embodiment, the film deposition method for the thin film is a plating method in the step of coating the thin film on the reflection surface.

In a further preferred embodiment, the film deposition method for the thin film is an ion plating method in the step of coating the thin film on the reflection surface.

The present invention also provides a mirror device formed on a substrate, having at least two reflection surfaces each comprising a surface vertical to the surface of the substrate, in which the angle formed by the at least two reflection surfaces is 90°, and which is manufactured by the mirror manufacturing method described above.

In a preferred embodiment, the two reflection surfaces formed to the substrate are identical crystal faces.

The present invention further provides a mirror device in which the substrate is a SOI (Silicon on Insulator) substrate, and a fixed mirror having a surface vertical to the surface of the SOI substrate, a movable mirror, a movable portion including the movable mirror and a flame including the fixed mirror are formed on one silicone layer and springs supporting the movable portion is formed on the other silicone layer, which is prepared by the method of manufacturing the mirror described above.

The present invention further provides an optical switch comprising two sets of movable retro-reflectors, two sets of fixed retro-reflectors, fixing portions integral with the fixed retro-reflectors, movable portions integral with the movable retro-reflectors, and springs for connecting the fixed portions and the movable portions, which is adapted to switch optical channels by driving the movable portion and in which the movable retro-reflector and the fixed retro-reflector are prepared by the method of manufacturing the mirror described above.

The present invention further provides a method of manufacturing an optical switch comprising a step of forming a retro-reflector of preparing movable retro-reflectors, fixed retro-reflectors, movable portions and fixed portions to a substrate and a step of forming springs, wherein the movable retro-reflector and the fixed retro-reflector are prepared by the method of manufacturing the mirror described above.

In a preferred embodiment, the spring forming step is conducted after the retro-reflector forming step.

In a further preferred embodiment, the substrate is a SOI substrate, and the retro-reflector forming step is conducted to one silicon layer and the spring forming step is conducted to the other silicon layer.

According to the invention, since the surface substantially parallel with the crystal face perpendicular to the crystal face of the surface of the silicon substrate can be exposed by conducting anisotropic dry etching using DRIE, and, thereafter, the crystal face can be exposed by the anisotropic wet etching, a reflection surface of high verticality to the surface of the silicon substrate and having small surface roughness can be obtained. Further, by coating the metal film to the micro-mirror, a high reflectivity can be obtained relative to the wavelength used in the optical communication. Further, by coating the ferroelectric multi-layered film to the surface of the reflection surface, the micro-mirror can be used as a filter.

Further by using the silicon substrate in which the crystal face on the surface is {100}, a micro-mirror having a reflection surface at {110} face or {111} face, vertical to the silicon substrate and having reduced surface roughness can be manufactured.

Further, by using the silicon substrate in which the crystal face on the surface is {110}, a micro-mirror having a reflection surface at {100} face, {110} face, or {111} face, vertical to the silicon substrate and having reduced surface roughness can be manufactured.

Further, by using the silicon substrate in which the crystal face on the surface is {111}, a micro-mirror having a reflection surface at {110} face, vertical to the silicon substrate and having reduced surface roughness can be manufactured.

Further, since the two retro-reflectors each having the reflection surface prepared according to the manufacturing method of the invention has the reflection surface at the crystal face, both the angle formed between the two reflection surfaces and the angle formed between the reflection surface and the substrate are 90° and the surface roughness is decreased by using the anisotropic wet etching, high reflectivity can be obtained. Further, by coating the retro-reflector with a metal film such as of Al or Au, a high reflectivity can be obtained to a light at a wavelength used in the optical communication. Alternatively, in a case of forming a dielectric multi-layered film to at least one reflection surface, the retro-reflector can be used as a filter.

Further, a mirror device including the mirror having feature of the invention can be manufactured. Further, by manufacturing the device using the SOI substrate, the film thickness can be controlled and the scattering of the spring constant can be suppressed. Further, in a case of manufacturing the mirror portion, when a dummy pattern is disposed to the outer periphery of the mirror device pattern to increase the consumption amount of the etchant gas at the outer periphery of the substrate by the silicon exposed area of the dummy pattern, the etching distribution can be improved, the under etching amount can be decreased and the scattering of angle of the mirror in the substrate can be decreased thereby capable of improving the yield of the mirror device. Further, with respect to the arrangement of the dummy pattern, when L is left by several mm or more from the outer periphery of the substrate, the strength of the substrate upon handling can be increased.

### BRIEF DESCRIPTION OF THE DRAWINGS

Preferred embodiments of the present invention will be described in details based on the drawings, wherein

FIG. 1 is a cross sectional view showing a method of manufacturing a micro-mirror according to Embodiment 1 of the invention;

FIG. 2 is a schematic view of a micro-mirror manufactured by the manufacturing method shown in FIG. 1;

FIG. 3 is an enlarged cross sectional view for a portions A and B shown in FIG. 1;

FIG. 4 is a perspective view of a retro-reflector according to Embodiment 5 of the invention;

FIG. 5 is a perspective view for the surface of a silicon substrate in FIG. 1A:

FIG. 6 is an upper plan view for explaining an example of a mirror device according to Embodiment 6 of the invention;

FIG. 7 is an upper plan view in which a pattern and a dummy pattern of a mirror device are disposed on an SOI substrate;

FIG. 8 is a cross sectional view for explaining a method of manufacturing the mirror device shown in FIG. 6;

FIG. 9 is a graph showing a relation between the side wall angle after DRIE etching and the reflection loss; and

FIG. 10 is a graph showing a relation between the side wall roughness and the reflection loss after DRIE etching

### DESCRIPTION OF PREFERRED EMBODIMENTS

Embodiment 1

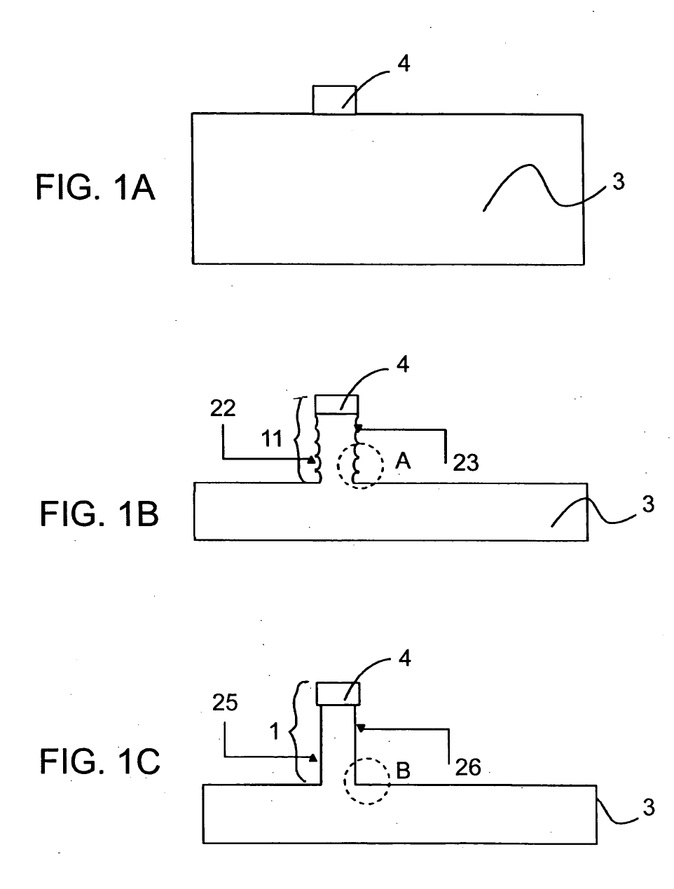

FIG. 1 is a cross sectional view for explaining a method of manufacturing a micro-mirror according to Embodiment 1 of the invention in which FIG. 1A shows a sate of forming a mask material 4 on s silicon substrate 3, FIG. 1B shows a state of conducting deep grooving etching of silicon by using DRIE and FIG. 1C shows a state of conducting anisotropic wet etching using an alkali solution.

A micro-mirror 1 is manufactured by using a silicon micro machining process technique. In FIG. 1A, the mask material 4 comprises a resist, silicon dioxide (SiO₂), or a metal such as chromium (Cr) or aluminum (Al). The mask material 4 is formed by photolithography.

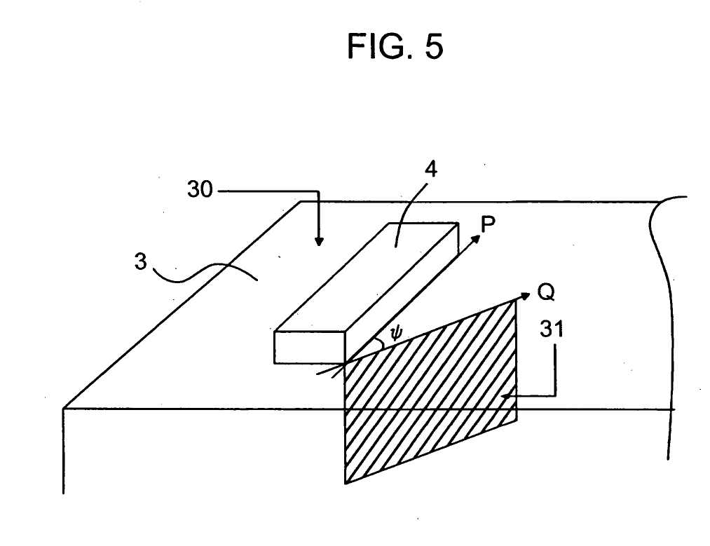

FIG. 5 is a perspective view in the state of FIG. 1A. On the silicon substrate 3, an angle formed between the pattern direction P for the mask material 4 and a line of intersection Q of a crystal face 31 on a crystal face 30 is defined as a patterning angle φ. The crystal face 31 indicated by hatched lines is a crystal face vertical to the crystal face 30 at the surface of the silicon substrate 3, and this is a crystal face parallel with the reflection surface to be described later. For example, in a case where the crystal face 30 on the surface of the silicon substrate 3 is {100} face, the crystal face 31 is, for example, {100} face or {110} face. The patterning is desirably applied such that the patterning angle φ is 0° and it is generally necessary for positional alignment such that the angle is within a range of ±3°.

Then, as shown in FIG. 1B, a portion other than the mask material 4 is etched by anisotropic dry etching to form a micro-mirror precursor 11 having reflection surfaces 22 and 23. The depth for etching by using DRIE is made identical with or larger than the diameter of a beam irradiated to the reflection surfaces 22 and 23. Further, since the deep grooving etching comprises repetition of an etching step and a polymerization step, unevenness referred to as “scallop” is present on the surface of the reflection surfaces 22 and 23 in a micro point of view.

FIG. 3A is a cross sectional view enlarging the portion A in FIG. 1B. The angle θ1 is usually 90±3°. Further, since the patterning angle φ is defined as within a range of 0°±3° as has been described for FIG. 5, a plane having a crystal face approximate to the crystal face 31 is exposed at the reflection surface 23. The unevenness is a scallop formed by the deep grooving etching step, and the height D1 of the scallop is usually 50 nm or more. As D1 is larger, the reflectivity is lowered. That is, the surface roughness increases and the reflectivity is lowered at the reflection surfaces 22 and 23 by the scallop. Accordingly, in the state of the reflection surfaces 22 and 13, it is difficult to use as a micro-mirror of high reflectivity.

By the polymerization step of the deep grooving etching, polymerization film comprising fluorides is deposited on the surface of the reflection surfaces 22 and 23. Since the polymerization film may possibly formed a protection films or micromasks upon anisotropic wet etching of silicon to be described later, it is preferable to remove them. In the cleaning step for removing the polymerization film, ashing by oxygen plasma or argon plasma or acid cleaning with sulfuric acid and hydrogen peroxide or hot sulfuric acid is used. Since the polymerization film is removed chemically by irradiating the oxygen plasma to the silicon substrate 3, increase of the surface roughness caused by the micromasks formed of the polymerization film can be prevented. Further, when the argon plasma is irradiated instead of the oxygen plasma, since the ionic mass of argon is larger compared with that of oxygen, the sputtering effect is enhanced. This can physically remove the impurities including the polymerization film deposited on the side wall. Further, in a case of using a metal such as Al for the mask, cleaning for the side wall and the removal of the mask can be conducted simultaneously by dipping the silicon substrate 3 in a hot sulfuric acid or a liquid mixture of sulfuric acid and an aqueous hydrogen peroxide.

FIG. 1C shows a state of applying the anisotropic wet etching after forming the reflection surfaces 22 and 23. The surfaces of the reflection surfaces 22 and 23 shown in FIG. 1C are etched to decrease the surface roughness. In the anisotropic wet etching, the etching rate for the crystal face 31 shown in FIG. 5 can be changed depending on conditions such as temperature or etchant concentration. By decreasing the etching rate for the crystal face 31 and increasing the etching rate for other crystal faces, only the crystal face 31 can be exposed selectively. Thus, the reflection surfaces 22 and 23 as the crystal face substantially parallel with the crystal face 31 form reflection surfaces 25 and 26 comprising the crystal face 31. That is, since the formed reflection surface is the crystal surface 31 vertical to the crystal face 30 of the silicon substrate 3, the micro-mirror 11 having the high verticality and small surface roughness can be manufactured as a result.

The etchant used for the etching is KOH, TMAH, or ammonia, or it may be KOH with addition of IPA (Isopropyl Alcohol), TMAH with addition of silicon, TMAH with addition of silicon and ammonium persulfate, or ammonia with addition of arsenic oxide.

In a case of using TMAH as the etchant, the liquid temperature is 100° C. or lower. However, when the temperature of TMAH is 60° C. or lower, since pits appear on the crystal face 31 and the surface roughness is increased, it is difficult to use the surface as the mirror surface. Further, in a case where the temperature of TMAH is 90° C. or higher, since the etching rate to the crystal face 31 is increased compared with that at the low temperature, it is difficult to control the etching amount. Further, since other crystal faces appear to the crystal face 31 as the amount of etching becomes excessive, the surface roughness is increased. That is, in a case of using TMAH as the etchant, it is preferred that the etching is conducted within a range at a temperature of TMAH from 60 to 70° C., for an etching time from 5 min to 10 min and with an etching amount of 0.5 to 3 μm.

Further, in a case of using KOH with addition of IPA as the etchant, the etching rate for {100} face can be made lower compared with that for other crystal faces. Thus, {110} face more tends to remain and a smooth surface with less surface roughness can be obtained. Ina case of using TMAH with addition of silicon or with addition of silicon and ammonium persulfate as the etchant, etching of metal such as Al can be prevented. Thus, silicon etching can be conducted even when a portion covered with a metal such as Al is present in the device and the degree of freedom in view of the processing is improved. Further, also in a case of using ammonia with addition of arsenic oxide as the etchant, the surface roughness can be suppressed.

FIG. 3B is an enlarged cross sectional view for the portion B in FIG. 1C. Since the crystal face 31 is exposed by the anisotropic wet etching, the surface roughness D2 of the reflection can be decreased to 30 nm or less. Further, since the crystal face 31 is in perpendicular with the crystal face 30 at the surface of the silicon substrate 3, the angle θ2 between the silicon substrate 3 and the reflection surface 26 is 90°. Further, when the oxide film is removed by isotropic wet etching with fluoro sulfuric acid, or thermal oxidation followed by wet etching, the surface roughness of the reflection surfaces 25 and 26 can be decreased further.

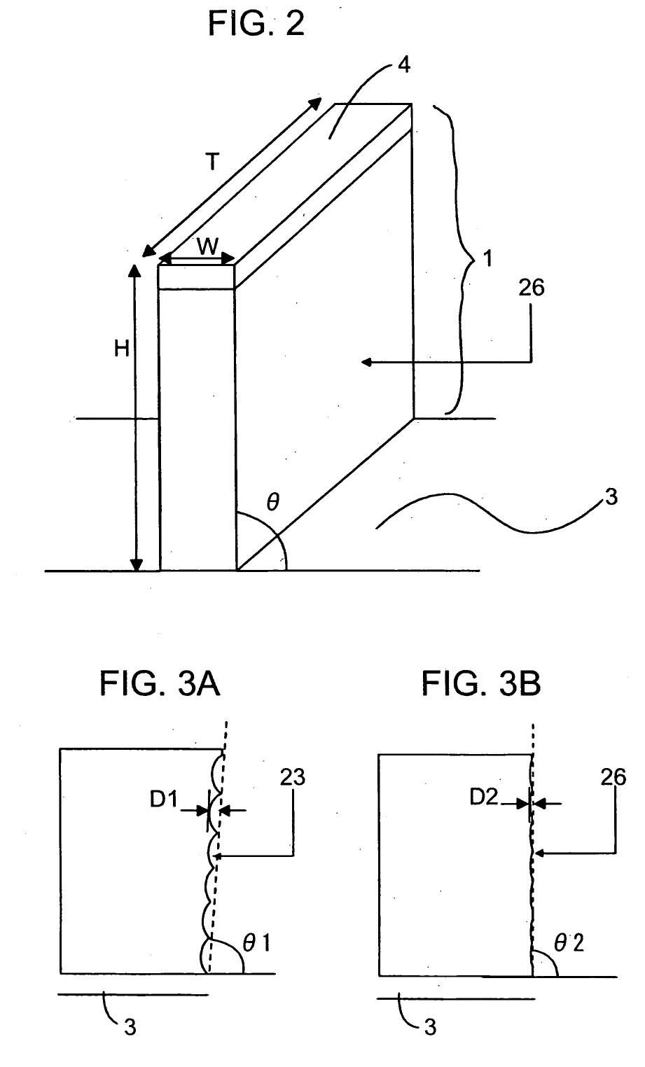

FIG. 2 is a schematic view of a micro-mirror 1 manufactured by the manufacturing method shown in FIG. 1. The micro-mirror 1 has a height H of several hundred μm or less, a width W of several hundred μm or less and a thickness T of several mm or less, and the angle formed between the silicon substrate 3 and the micro-mirror 1 is 90±2°. The mask 4 may be removed.

Further, depending on the wavelength of a light incident to the reflection surfaces 25 and 26 comprising silicon, the reflection surfaces 25 and 26 do not reflect the light but allow the light to transmit therethrough. Then, a high reflectivity to the wavelength of the light incident to the reflection surfaces 25 and 26 can be obtained by coating the reflection surface with a metal film of a material having a high reflectivity for the wavelength of the light incident to the reflection surfaces 25 and 26, such as Al for the range of the ultraviolet light, Al or gold (Au) for the range of the visible light, Au or copper (Cu) for the range of the infrared light by vacuum vapor deposition, sputtering, plating or ion plating. Further, the micro-mirror 1 can also be used as a filter by coating the surface of the reflection surfaces 25 and the 26 with a multi-layered dielectric film.

In the step of coating the metal film by vapor deposition, the metal film can be coated most efficiently by locating a vapor deposition source vertical to the reflection surface of the micro-mirror. However, in a case where many micro-mirrors are formed on one substrate, micro-mirrors formed back and forth cause interference and metal films can not be vapor deposited to a necessary portion. In such a case, by slanting the silicon substrate 3 relative to the vapor deposition source and conducting vapor deposition obliquely, the metal film can be coated to the necessary portion with no hindrance by the micro-mirrors located back and forth. Further, sputtering can coat a dense and less peeling metal film. Plating can coat a uniform metal film even for a portion including large steps and can coat a thick metal film all at once. Ion plating can coat a metal film of high adhesion strength at low temperature.

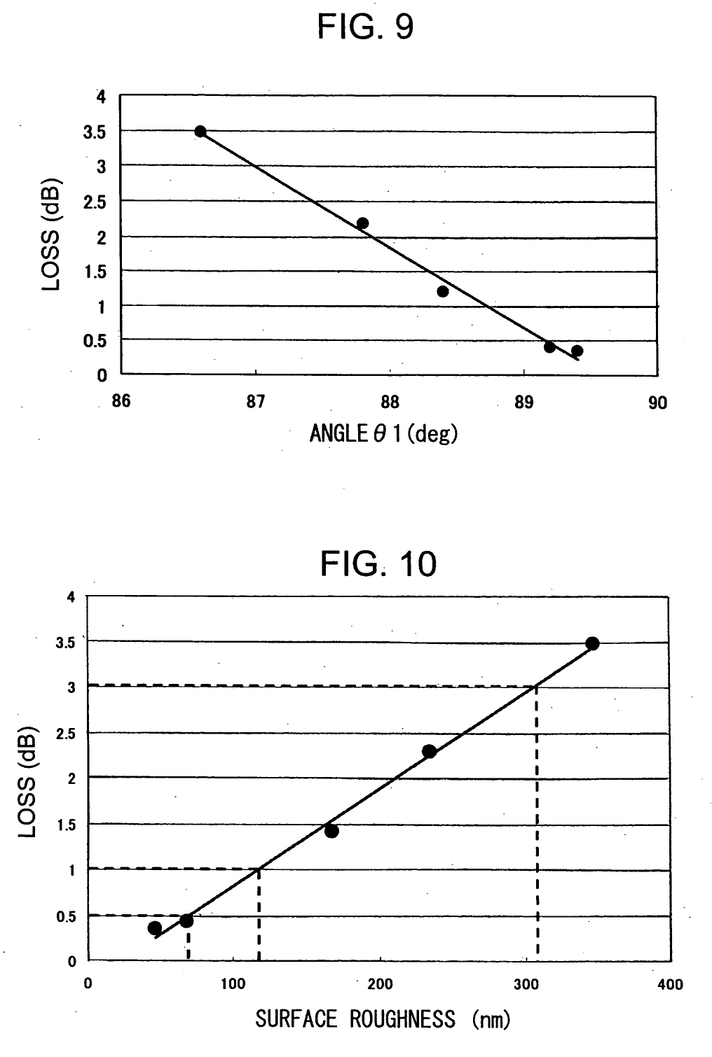

FIG. 9 is a graph showing a relation between the θ1 formed between the reflection surfaces 22 and 23 and the substrate surface after DRIE etching, and the reflection loss upon irradiating an infrared light (wavelength λ=1550 nm) to the reflection surfaces 25 and 26 after coating gold as a metal film to the surfaces of the reflection surfaces 25 and 26 after DRIE etching. Plotted points correspond to experimental data and a straight line indicates linear approximation based on the experimental data. It can be seen that the reflection loss is decrease as the θ1 approaches 90°. Considering that the experimental data in the positive direction is in right-to-left symmetry relative to 90° in view of the structure of the single crystal silicon, this is identical with the data in the negative direction. The reflection loss of the mirror device is preferably 3 dB or less, in which it is necessary as the angular condition that the angle θ1 is 90°±3°. Further, for improving the reflection loss of the mirror device as 1 dB or less it is necessary that the angle θ1 is 90° ±1.5° or less as the angular condition. For further improving the reflection loss as 0.5 dB or less it is necessary that the angle θ1 is 90°±1° as the angular condition.

Further, FIG. 10 is a graph showing a relation between the surface roughness on the reflection surfaces 22 and 23 and the reflection loss upon irradiating an infrared light to the reflection surfaces 25 and 26 after coating gold as a metal film to the surfaces of the reflection surfaces 25 and 26 after DRIE etching. Plotted points correspond to experimental data and a straight line indicates linear approximation based on the experimental data. It can be seen that the reflection loss increases as the surface roughness on the reflection surfaces 22 and 23 increases. The reflection loss of the mirror device is desirably 3 dB or less and, in this case, it is necessary as the surface roughness condition that the surface roughness is 300 nm or less. Further, in order to improve the reflection loss of the mirror device as 1 dB or less, it is necessary that the surface roughness is 100 nm or less as the surface roughness condition. In order to further improve the reflection loss as 0.5 dB or less, it is necessary that the surface roughness is 100 nm or less as the surface roughness condition. Further, the reflection loss was measured by using, as a reference, the reflection intensity on the reflection surface formed by depositing gold on a smooth glass or silicon substrate. Further, the optical system is adjusted on every measurement of reflection loss and the value for the smallest reflection loss is used as the data. Further, the angle θ1 and the surface roughness of the reflection surfaces 22 and 23 after DRIE fabrication does not necessarily satisfy the angular conditions and the surface roughness conditions described above for the entire range of the height H of the micro-mirror 1 but it may suffice that at least the portion corresponding to the range of the reflection surfaces 25 and 26 to be irradiated with the beam can satisfy the angular condition and the surface roughness condition as described above.

As has been described above according to Embodiment 1 of the invention, since the crystal face substantially parallel with the crystal face 31 in perpendicular to the crystal face 30 at the surface of the silicon substrate can be exposed by anisotropic dry etching using DRIE and then the crystal face 31 can be exposed by anisotropic wet etching, reflection surfaces 25 and 26 having high verticality and with small surface roughness can be obtained. Further, since the anisotropic dry etching by DRIE is used, the mask shape can be simplified compared with the case of manufacturing the mirror only by the anisotropic wet etching. This can decrease range necessary for forming each of micro-mirrors and the micro-mirrors 1 can be integrated more densely. Further, since the surface substantially parallel with the crystal face 31 is exposed by using DRIE, the micro-mirror 1 can be formed with an optional outer profile even when the anisotropic wet etching time is short. Accordingly, also in a case of changing the mask pattern, a micro-mirror having a verticality and high reflectivity can be manufactured easily with no particular conditioning for DRIE. Further, when the micro-mirror 1 is coated with the metal film, a high reflectivity to the wavelength used in optical communication can be obtained.

Further, the manufacturing method described for Embodiment 1 is applicable not only to the formation of the reflection surface of the micro-mirror but also to the manufacture of a device requiring formation of a surface having high verticality and small surface roughness by conducting etching to a silicon substrate at a high aspect ratio.

Embodiment 2

Then, a method of manufacturing a micro-mirror according to Embodiment 2 of the invention is to be described. Constitutions identical with those in Embodiment 1 carry same reference numerals for which duplicate descriptions are to be omitted. Description is to be made for a silicon substrate in which the crystal face 30 is {100} with respect the crystallographic direction shown in FIG. 5 according to Embodiment 1. The crystal face 31 in perpendicular to the crystal face 30 is {100} face and {110} face. For example, in a case of preparing reflection surfaces 25 and 26 each comprising {100} face to a {100} substrate, a resist is coated on the {100} substrate, and a mask material 4 is patterned such that the pattering direction P of the mask material 4 shown in FIG. 5 is in the <100> direction. Then, deep grooving etching is applied to silicon by DRIE to expose the reflection surfaces 22 and 23. In this case, while the reflection surfaces 22, and 23 are not completely {100} face, but they form surfaces nearly equal with {100} face.

Then, the substrate is dipped in an alkali solution and anisotropic wet etching is conducted. By the anisotropic etching, {100} face is exposed utilizing the difference of the etching rate. When {100} face is exposed, a high verticality is obtained also relative to the crystal face 30 at the surface of the silicon substrate 3 and reflection surfaces 25 and 26 of small surface roughness can be obtained. Further, by the same procedure also for the {110} face, the crystal surface 30 at the surface of the silicon substrate 3 is {100} and the crystal face 31 forming the reflection surfaces 25 and 26 is {110} face. In any of the cases, a micro-mirror having high verticality and less surface roughness can be manufactured.

As has been described above, according to the Preferred Embodiment 2 of the invention, by using a silicon substrate having the crystal face 30 of {100}, a micro-mirror having reflection surfaces of the crystal face 31 consisting of {100} face or {110} face, vertical to the silicon substrate and with reduced surface roughness can be manufactured.

Embodiment 3

Then, a method of manufacturing a micro-mirror according to Embodiment 3 of the invention is to be described. Constitutions identical with those in Embodiment 1 carry same reference numerals for which duplicate descriptions are to be omitted. Description is to be made for a silicon substrate in which the crystal face 30 is {110} with respect the crystallographic direction shown in FIG. 5 according to Embodiment 1. The crystal face 31 in perpendicular to the crystal face 30 is {100} face, {110} face and {111} face. For example, in a case of preparing reflection surfaces 25 and 26 each comprising {100} face to a {110} substrate, a resist is coated on the {110} substrate, and a mask material 4 is patterned such that the pattering direction P of the mask material 4 shown in FIG. 5 is in the <100> direction. Then, deep grooving etching is applied to silicon by DRIE to expose the reflection surfaces 22 and 23. In this case, while the reflection surfaces 22, and 23 are not completely {100} face, but they form surfaces substantially parallel with {100} face.

Then, the substrate is dipped in an alkali solution and anisotropic wet etching is conducted. By the anisotropic etching, {100} face is exposed utilizing the difference of the etching rate. When {100} face is exposed, a high verticality is obtained also relative to the crystal face 30 at the surface of the silicon substrate 3 and reflection surfaces 25 and 26 of small surface roughness can be obtained. Further, by the same procedure also for the {110} face or {111} face, the crystal surface 30 at the surface of the silicon substrate 3 is {110} and the crystal face 31 forming the reflection surfaces 25 and 26 is {100} face or {111} face. In any of the cases, a micro-mirror having high verticality and less surface roughness can be manufactured.

As has been described above, according to Embodiment 3 of the invention, by using a silicon substrate having the crystal face 30 of {110}, a micro-mirror having reflection surfaces of the crystal face 31 consisting of {100} face, {110} face or {111} face, vertical to the silicon substrate and with reduced surface roughness can be manufactured.

Embodiment 4

Then, a method of manufacturing a micro-mirror according to Embodiment 4 of the invention is to be described. Constitutions identical with those in Embodiment 1 carry same reference numerals for which duplicate descriptions are to be omitted. Description is to be made for a silicon substrate in which the crystal face 30 is {111} with respect the crystallographic direction shown in FIG. 5 according to Embodiment 1. The crystal face in perpendicular to {111} face is {110} face. For example, in a case of preparing reflection surfaces 25 and 26 each-comprising {110} face to a {111} substrate, a resist is coated on the {111} substrate, and a mask material 4 is patterned such that the pattering direction P of the mask material 4 shown in FIG. 5 is in the <110> direction. Then, deep grooving etching is applied to silicon by DRIE to expose the reflection surfaces 22 and 23. In this case, while the reflection surfaces 22, and 23 are not completely {110} face, but they form surfaces nearly equal with {110} face.

Then, the substrate is dipped in an alkali solution and anisotropic wet etching is conducted. By the anisotropic etching, {110} face is exposed utilizing the difference of the etching rate. When {110} face is exposed, a high verticality is obtained also relative to the crystal face 30 at the surface of the silicon substrate 3 and reflection surfaces 25 and 26 of small surface roughness can be obtained. As described above, a micro-mirror having high verticality and less surface roughness can be manufactured.

As has been described above, according to Embodiment 4 of the invention, by using a silicon substrate having the crystal face 30 of {111}, a micro-mirror having reflection surfaces of the crystal face 31 consisting of {110} face, vertical to the silicon substrate and with reduced surface roughness can be manufactured.

Embodiment 5

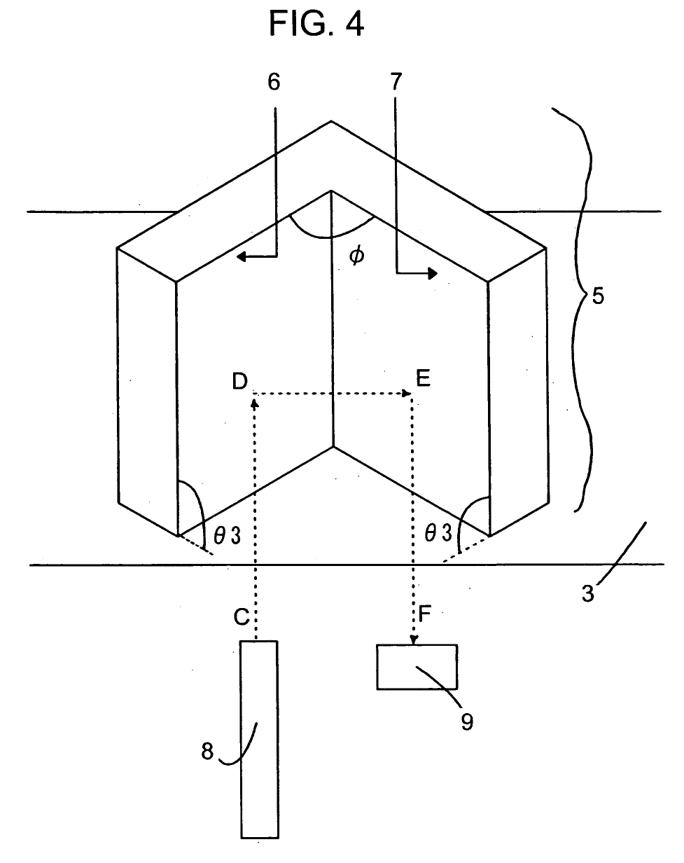

FIG. 4 is a perspective view of a mirror device according to Embodiment 5 of the invention. The manufacturing method for the mirror device is identical with the manufacturing method for Embodiment 1 and the device is manufactured by the combination of an anisotropic dry etching step and an anisotropic wet etching step. In this embodiment, description is to be made to an example where a mirror functions as a retro-reflector. A retro-reflector 5 comprises two reflection surfaces 6 and 7 having a feature of the crystal face 31 described in Embodiment 1. Each of the dimensions for the two reflection surfaces 6 and 7 constituting the retro-reflector is identical with that in the micro-mirror 1.

For example, by arranging an optical fiber 8 on the side of the reflection surface 6 and a detector 9 on the side of the reflection surface 7, a light outgoing from the optical fiber 6 is reflected at the reflection surfaces 6 and 7 and enters to the detector 9 through the optical channel of C→D→E→F and detected. What is important for the retro-reflector is that CD and EF are parallel with each other. In order to satisfy the condition, it is necessary that both the angle θ3 to the silicon substrate 3 and the angle φ between each of the reflection surfaces 6 and 7 are 90°. Then, a retro-reflector 6 of a high accuracy capable of satisfying the conditions described above can be manufactured by forming the two reflection surfaces 6 and 7 with crystal faces perpendicular to each other also as shown in Embodiment 1. Further, the mask pattern can be simplified by manufacturing the device by anisotropic dry etching. Thus, it is possible to decrease the mask range necessary for formation of each retro-reflector 5 and arrange the retro-reflector 5 in a highly integrated state. Further, the two reflection surfaces 6 and 7 constituting the retro-reflector 5 are preferably identical crystal faces so that the surface roughness, the angle φ, and the angle θ3 can be controlled easily by the etching conditions such as time or temperature in the anisotropic wet etching. For example, in a case of using a [100] substrate, both of the reflection surfaces 6 and 7 are [100] face and, in a case of using a [100] substrate, both of the reflection surfaces 6 and 7 are [100] or [110] face. However, it is not always necessary that they are identical crystal face.

As has been described above according to Embodiment 5, the retro-reflector 5 having the two reflection surfaces 6 and 7 manufactured according to the manufacturing method shown in Embodiment 1 is adaptable also to higher integration degree, each of the angle φ formed between the two reflection surfaces 6 and 7 or the angle θ3 formed between the reflection surfaces 6, 7 and the silicon substrate 3 is 90° and since the surface roughness is decreased by using the anisotropic wet etching, high reflectivity can be obtained. Further, the retro-reflector 5 can be provided with a high reflectivity to a light at a wavelength used in optical communication when it is coated with a metal film such as of Au by using, for example, vacuum vapor deposition, sputtering or ion plating. Alternatively, in a case of forming a dielectric multi-layered film on the reflection surfaces 6 and 7, the retro-reflector 5 can also be used as a filter. In a case of using the retro-reflector to which incident and detection elements can be arranged on one side of the mirror for an optical device, since the two reflection surfaces 6 and 7 can be manufactured at a high accuracy, it can provide a high performance optical device in a compact optical layout. Further, the mirror device having the foregoing feature is applicable not only to the retro-reflector but also to various optical devices.

Embodiment 6

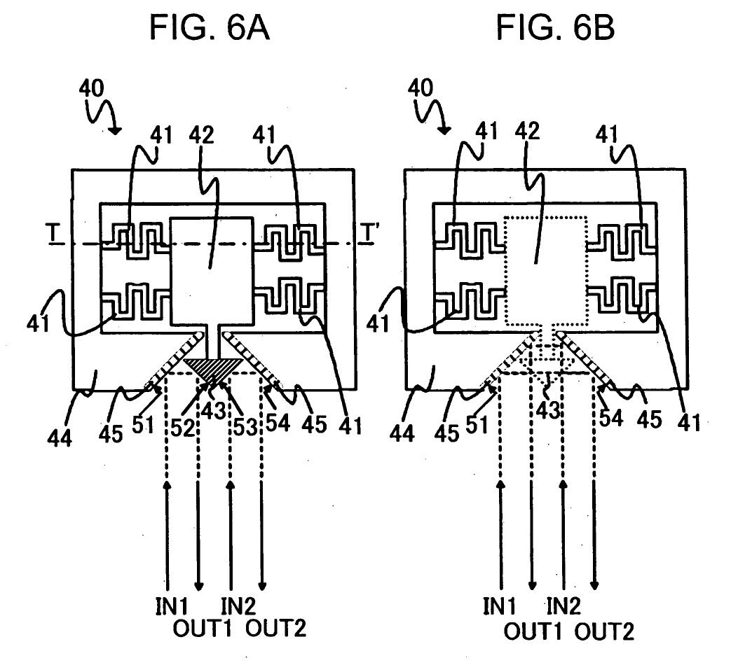

FIG. 6 is an upper plan view for explaining a 2×2 optical switch as an example of a mirror device according to Embodiment 6 of the invention in which FIG. 6A shows a state where a movable mirror 43 put incorporated in an optical channel and FIG. 6B shows a state where a movable mirror 43 is not put in the optical channel. An optical switch 40 shown, as an example, in FIG. 6A and FIG. 6B comprises a movable mirror 43, a fixed mirror 45, a stage 42, four springs 41, and a frame 44. The stage 42 integral with the movable mirror 43 is connected by way of four springs 41 to the frame 44. Further, the fixed mirror 45 is integral with the frame 44. A magnetic member is bonded on the stage 42 and the stage 42 is moved upward and downward relative to the sheet of the drawing by a source generating magnetic force such as an electromagnet or permanent magnet to move the movable mirror 43 into and out of the optical channel.

In FIG. 6A, when a light introduced through a predetermined optical cable (not illustrated) to the optical switch 40 is passed through an incident optical channel IN1 and emitted from one end thereof to a fixed mirror surface 51, it enters at an incident angle of about 45° relative to the surface of the fixed mirror 51 and is then reflected at an angle of about 45°. Successively, a light reflected at the surface of the fixed mirror 51 enters at an incident angle of about 45° to the movable mirror surface 52 and is then reflected at a reflection angle of about 45°. Then, the light reflected at the moveable mirror surface 52 enters an outgoing optical channel OUT1 from one end thereof and is transmitted through the outgoing optical channel OUT1 to the outside of the optical switch 40. In the same manner, a light passing through the incident optical channel IN2 and is then emitted from one end thereof to the movable mirror surface 53 is reflected at the movable mirror surface 53 and the fixed mirror surface 54 and then enters the outgoing optical channel OUT 2 from one end thereof and then transmitted to the outside of the optical switch 40. As described above, in FIG. 6A, the incident optical channel IN1 and the outgoing optical channel OUT1, or the incident optical channel IN2 and the outgoing optical channel OUT2 constitute an incident-emission optical channel pair and optical transmission is conducted on every pairs.

Further, the movable mirror 43 is movable upward and downward relative to the sheet of the drawing and FIG. 6B shows a state where the movable mirror 43 is out of the optical channel. When a light introduced through an optical cable (not illustrated) into the optical switch 40 passes the incident optical channel IN1 and is emitted from one end thereof to the fixed mirror surface 51, it enters to the fixed mirror surface 51 at an incident angle of about 45°, and is reflected at a reflection angle of about 45°. The light reflected at the fixed mirror surface 51 passes above the movable mirror surface 43 enters the fixed mirror surface 54 at an incident angle of about 45° and is reflected at a reflection angle of about 45°. Then, the light reflected at the fixed mirror surface 54 enters the outgoing optical channel OUT2 from one end thereof and then transmitted to the outside of the optical switch 40 through the channel.

On the other hand, a light passing through the incident optical channel IN2 and is emitted from one end thereof to the fixed mirror surface 54 passes above the movable mirror 43, incidents to the fixed mirror surface 51 at an incident angle of about 45°, reflected at a reflection angle of about 45°, passes above the movable mirror 43, again enters the outgoing optical channel OUT1 from and one end thereof and then transmitted to the outside of the optical switch 40. That is, in FIG. 6B, the incident optical channel IN1 and the outgoing optical channel OUT2, or the incident optical channel IN2 and the outgoing optical channel OUT1 constitute incident-emitting optical channel pair and optical transmission is conducted on every pairs.

As described above, according to the optical channel changing mechanism in the optical switch 40, by moving the movable mirror 43, the optical channel can be switched by changing the combination of the incident optical channel and the outgoing optical channel that transmit light to each other. The optical channel changing mechanism is useful particularly in a case where the incident optical channel and the outgoing optical channel are parallel with each other, thereby capable of decreasing the mounting space for each of the optical channels and attaining micro-miniaturization of the optical switch. Further, the two fixed mirror surfaces 51 and 54 and the two movable mirror surfaces 52 and 53 incorporated in the optical switch 40 have a feature of the crystal face 31 described in Embodiment 1. Each of the dimensions for the mirror surfaces 51, 52, 53 and 54 is equal with that of the micro-mirror 1 described in Embodiment 1. For example, in a case of using a {110} substrate, the crystal face constituting the four mirror surfaces 51, 52, 53, and 54 is {100} face, and in a case of using the {100} substrate, the crystal face constituting the four mirror surfaces 51, 52, 53 and 54 is {100} or {110} face. However, it is not always necessary that the four mirror surfaces 51, 52, 53, and 54 are identical crystal face.

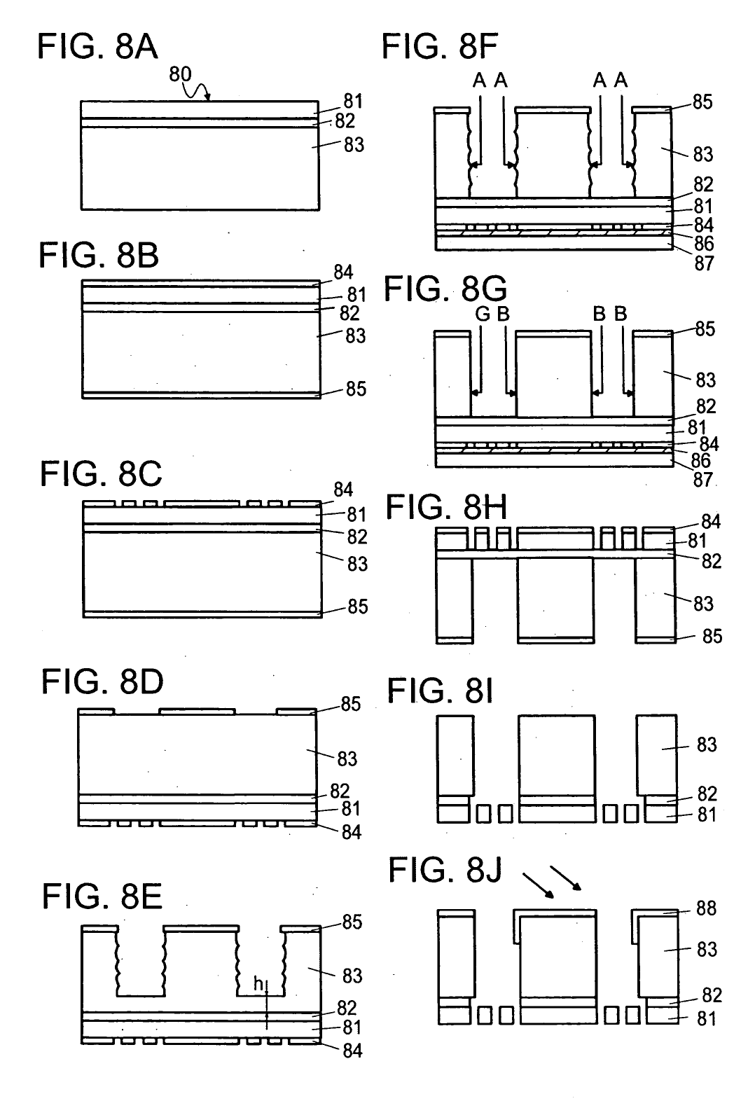

FIG. 8 is a cross sectional view for explaining a method of manufacturing the mirror device described in FIG. 6. FIG. 8A shows an SOI substrate 80 used for manufacture in which the thickness of a BOX oxide film 82 is several μm or more and a thickness of a support layer 83 is several hundreds μm or more. A spring 41 is formed to an active layer 81, and a movable mirror 43 and a fixed mirror 45 are formed to the support layer 83. Then, as shown in FIG. 8B, a mask material 84 is deposited by several μm to the active layer 81. The mask material 84 is a thermally oxide film, or silicon dioxide or a metal such as Al formed by CVD, and any material may be used so long as it can form an etching mask for silicon. Successively, as shown in FIG. 8C, a spring pattern is formed by a photolithography to the mask material 84. The mask material 84 is patterned by dry or wet etching. Further, a mask material 85 is deposited to the support layer 83. The mask material 85 is identical with the mask material 84.

Then, as shown in FIG. 8D, a mirror pattern is formed in the mask material 85. For patterning the mask material 85, anisotropic dry etching is used preferably in order to prevent retraction of the mask material 85 during etching. Successively as shown in FIG. 8E, the support layer 83 is applied with anisotropic dry etching by using DRIE. In this case, silicon is not etched all at once as far as the BOX oxide film 82 but etching is interrupted while leaving a height h. The height h is 100 μm or less. Then, as shown in FIG. 8F the active layer 81 is bonded by way of a mask material 84 and an adhesive 86 to a reinforcing substrate 87. After the bonding, the support layer 83 is etched as far as the BOX oxide film 82. The adhesive 86 may be any of positive resist, negative resist or resin easily soluble to a solvent. Further, the reinforcing substrate 87 is made of a brittle material such as glass or silicon or a metal such as aluminum or stainless steel.

Successively, as shown in FIG. 8G, anisotropic wet etching is conducted to smooth the mirror surface like in the step explained for the Embodiment 1. TMAH or KOH is used for the anisotropic wet etching. In this case, the silicon crystal face is exposed at B to form the mirror surface and the surface roughness is several tens nm. Then, as shown in FIG. 8H, the reinforcing substrate 87 is removed, and springs are formed to the active layer 81 by anisotropic drying etching. Successively, as shown in FIG. 8I, the BOX oxide film 82 etched by the wet etching to make the movable mirror 43 free. Finally, as shown in FIG. 8J, a metal film 88 is deposited on the support layer 83 in order to improve the reflectivity at the mirror surface. The deposition method includes, for example, vapor deposition, sputtering or plating, and the metal film 88 is made of gold or aluminum.

Such an optical switch 40 can be manufactured by using a silicone substrate in the same manner. In this case, the mirror and the spring pattern are formed to the surface and the rear face of the silicon substrate respectively and etching is applied. The height for the mirror and the thickness for the spring are determined respectively depending on the depth in the etching step. However, since etching distribution exists, it is difficult to make the etching depth constant and the thickness for the spring is not uniform. That is, since the thickness of the spring differs and the spring constant varies. The stage 42 can not be accurately moved vertically. Accordingly, it is considered that use of SOI substrate 8 in which the active layer 81 and the support layer 83 are separated by the BOX oxide film 82 is more suitable to the manufacture of the device than the usual silicon substrate since the BOX oxide film 82 functions as an etching stopper thereby facilitating the control for the film thickness.

In the manufacturing method, bubbles may sometimes be incorporated between the substrates upon appending the reinforcing substrate 87. In this case, when the entire active layer 81 remains, the substrate is less fractured during fabrication since a sufficient strength can be provided to the pressure difference between the bubbles and inside of the chamber during DRIE. Accordingly, it is more desirable that the spring portion is prepared on the active layer 81 after preparing the mirror portion to the support layer 83 and, finally, the BOX oxide film 82 is etched.

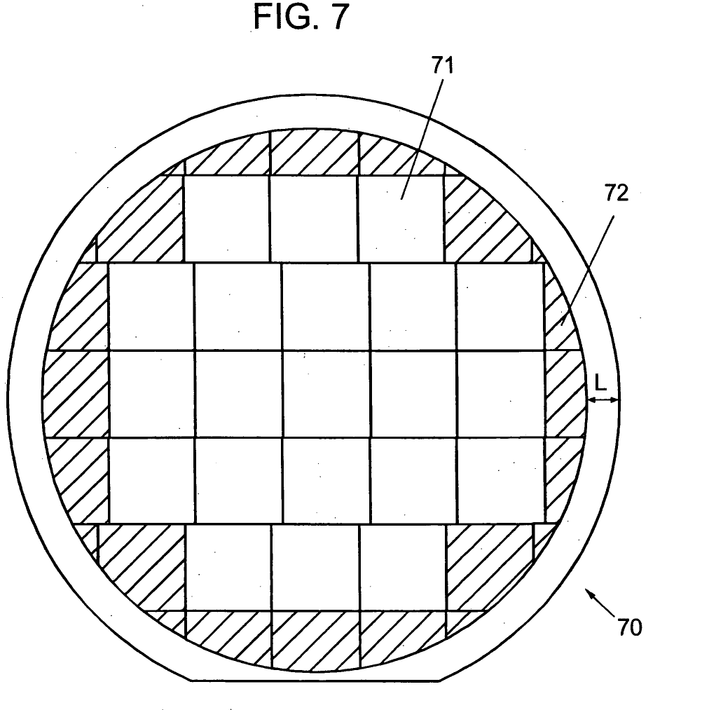

FIG. 7 is an upper plan view in which a mirror device pattern 71 and a dummy pattern 72 are disposed to the SOI substrate 70. The dummy pattern 72 may be a pattern identical with the mirror device pattern 71. It is preferred that the silicon exposure area of the dummy pattern 72 is larger than the silicon exposure area in the mirror device pattern 71. The consumption amount of the etchant gas at the outer periphery of the substrate can be increased by the silicon exposure area in the dummy pattern 72, to improve the etching distribution. Improvement in the etching distribution can reduce the amount of underetching thereby capable of reducing the scattering in the angle of mirrors within the substrate. Decrease in the scattering of angle can improve the yield of the mirror device. The dummy pattern may be present in the entire outer periphery of the substrate, but it is desirable to leave silicon only for the distance L from the outer periphery of the substrate. The outer periphery for L of the dummy pattern 72 is several millimeters or more.

As has been described above according to Embodiment 6, a mirror device including the mirror having the feature shown in Embodiment 1 can be manufactured. Further, the film thickness can be controlled to suppress the scattering of the spring constant by using the SOI substrate 80 upon manufacture. Further, when the mirror portion is manufactured, the etching distribution can be improved to decrease the amount of underetching and decrease the scattering of the angle of the mirror in the substrate by providing the dummy pattern 72 to the outer periphery of the mirror device pattern 71 thereby increasing the consumption amount of the etchant gas at the periphery of the substrate by the silicon exposure area of the dummy pattern 72, and improving the yield of the mirror device. Further, for the arrangement of the dummy pattern 72, by leaving L by several mm or more from the outer periphery of the substrate, the substrate strength upon handling can be improved. Further, the mirror device having the feature described above is applicable not only to the optical switch but also to various optical devices.

What is claimed is:

1. A method of manufacturing a mirror having a reflection surface vertical to the surface of a silicon substrate comprising;
a step of forming a mask for forming a mask material to the surface of the substrate, an anisotropic dry etching step of anisotropically dry etching the substrate, and an anisotropic wet etching step of anisotropically wet etching the substrate, and forming a surface substantially parallel with a crystal face in perpendicular to the surface of the substrate by the anisotropic dry etching step and then forming the reflection surface by the anisotropic wet etching step.

2. A method of manufacturing a mirror according to claim 1, wherein an angle formed between a portion of a fabrication side wall formed to the substrate at least corresponding to the reflection surface and the surface of the substrate is 90°±3° in the anisotropic dry etching step.

3. A method of manufacturing a mirror according to claim 1, wherein the surface roughness for the portion of the fabricated side wall formed to the substrate at least corresponding to the reflection surface is 300 nm or less in the anisotropic dry etching step.

4. A method of manufacturing a mirror according to claim 1, wherein a silicon exposed portion is provided to the outer periphery of the substrate in the anisotropic dry etching step.

5. A method of manufacturing a mirror according to claim 1, wherein a cleaning step is included between the anisotropic dry etching step and the anisotropic wet etching step.

6. A method of manufacturing a mirror according to claim 5, wherein oxygen plasma is irradiated to the substrate in the cleaning step.

7. A method of manufacturing a mirror according to claim 5, wherein argon plasma is irradiated to the substrate in the cleaning step.

8. A method of manufacturing a mirror according to claim 5, wherein the substrate is immersed in a liquid mixture of sulfuric acid and an aqueous hydrogen peroxide in the cleaning step.

9. A method of manufacturing a mirror according to claim 5, wherein the substrate is immersed in a heated sulfuric acid in the cleaning step.

10. A method of manufacturing a mirror according to claim 1, wherein the etchant is an aqueous solution of potassium hydroxide in the anisotropic wet etching step.

11. A method of manufacturing a mirror according to claim 1, wherein the etchant is potassium hydroxide with addition of isopropyl alcohol in the anisotropic wet etching step.

12. A method of manufacturing a mirror according to claim 1, wherein the etchant is tetramethyl ammonium hydroxide in the anisotropic wet etching step.

13. A method of manufacturing a mirror according to claim 12, wherein the etchant is tetramethyl ammonium hydroxide in the anisotropic wet etching step, and the liquid temperature is 60° C. or higher and 70° C. or lower.

14. A method of manufacturing a mirror according to claim 12, wherein the etchant is an aqueous solution of tetramethyl ammonium hydroxide in the anisotropic wet etching step, and the etching amount is 0.5 μm or more and 3 μm or less.

15. A method of manufacturing a mirror according to claim 1, wherein the etchant is tetramethyl ammonium hydroxide with addition of silicon in the anisotropic wet etching step.

16. A method of manufacturing a mirror according to claim 1, wherein the etchant is tetramethyl ammonium hydroxide with addition of silicon and ammonium persulfate in the anisotropic wet etching step.

17. A method of manufacturing a mirror according to claim 1, wherein the etchant is ammonia with addition of arsenic oxide in the anisotropic wet etching step.

18. A method of manufacturing a mirror according to claim 1, wherein the crystal face on the surface of the substrate is {100} face, and the crystal face as the reflection surface is {100} face or {110} face.

19. A method of manufacturing a mirror according to claim 1, wherein the crystal face in the surface of the substrate is {110} face, and the crystal face as the reflection surface is {100} face, {110} face, or {111} face.

20. A method of manufacturing a mirror according to claim 1, wherein the crystal face in the surface of the substrate is {111} face, and the crystal face as the reflection surface is {110} face.

21. A method of manufacturing a mirror according to claim 1, including a step of coating a thin film on the reflection surface.

22. A method of manufacturing a mirror according to claim 21, wherein the thin film is formed of at least one layer of a metal film in the step of coating the thin film on the reflection surface.

23. A method of manufacturing a mirror according to claim 21, wherein the thin film is formed of at least one layer of a dielectric material in the step of coating the thin film on the reflection surface.

24. A method of manufacturing a mirror according to claim 1, wherein the film deposition method for the thin film is an oblique vapor deposition method using a vacuum vapor deposition method in the step of coating the thin film on the reflection surface.

25. A method of manufacturing a mirror according to claim 1, wherein the film deposition method for the thin film is a sputtering method in the step of coating the thin film on the reflection surface.

26. A method of manufacturing a mirror according to claim 1, wherein the film deposition method for the thin film is a plating method in the step of coating the thin film on the reflection surface.

27. A method of manufacturing a mirror according to claim 1, wherein the film deposition method for the thin film is an ion plating method in the step of coating the thin film on the reflection surface.

28. A mirror device formed on a substrate, having at least two reflection surfaces each comprising a surface vertical to the surface of the substrate, in which the angle formed by the at least two reflection surfaces is 90°, and which is manufactured by the mirror manufacturing method according to claim 1.

29. A mirror device according to claim 28, wherein the two reflection surfaces formed to the substrate are identical crystal faces.

30. An optical switch comprising two sets of movable retro reflectors, two sets of fixed retro reflectors, fixing portions integral with the fixed retro reflectors, movable portions integral with the movable retro reflectors, and springs for connecting the fixed portions and the movable portions, which is adapted to switch optical channels by driving the movable portion and in which the movable retro reflector and the fixed retro reflector are prepared by the method of manufacturing mirror according to claim 1.

31. A method of manufacturing an optical switch comprising a step of forming a retro reflector of preparing movable retro reflectors, fixed retro reflectors, movable portions and fixed portions to a substrate and a step of forming springs, wherein the movable retro reflector and the fixed retro reflector are prepared by the method of manufacturing the mirror according to claim 1.

32. A method of manufacturing an optical switch according to claim 31, wherein the spring forming step is conducted after the retro reflector forming step.

33. A method of manufacturing an optical switch according to claim 31, wherein the substrate is an SOI substrate, and the retro reflector forming step is conducted to one silicon layer and the spring forming step is conducted to the other silicon layer.
